(19) United States
(12) Patent Application Publication
(10) Pub. No.: US 2015/0042784 A1
(43) Pub. Date: Feb. 12, 2015

(54) IMAGE PHOTOGRAPHING METHOD AND IMAGE PHOTOGRAPHING DEVICE

(71) Applicant: CANON KABUSHIKI KAISHA, Tokyo (JP)

(72) Inventor: Kenkichi Yamamoto, Tokyo (JP)

(21) Appl. No.: 14/339,482

(22) Filed: Jul. 24, 2014

(30) Foreign Application Priority Data
Aug. 8, 2013 (JP) 2013-165553

(51) Int. Cl. H04N 5/232; G06T 1/00

(52) U.S. Cl. CPC H04N 5/23245; G06T 1/0014; Y10S 901/15
USPC 348/94; 348/220.1; 901/15

(57) ABSTRACT

An object of the invention is to provide an image photographing method makes it possible to photograph a moving object at a desired photographing position without increasing the size of an image to be processed. The image photographing method includes a first photographing step in which a camera controller carries out continuous photographing in a first image quality, an estimation calculation step for estimating a timing at which the object to be photographed passes through a predetermined desired position range on the basis of a plurality of positions of the object to be photographed, the plurality of positions being obtained from the images photographed by the camera controller in the first photographing step, and a second photographing step in which the camera controller carries out photographing at the passing timing in a second image quality finer than the first image quality.

### BACKGROUND OF THE INVENTION

1. Field of the Invention

The present invention relates to an image photographing method and an image photographing device ideally suited for photographing an object to be photographed, such as a moving workpiece.

2. Description of the Related Art

Conventionally, in an automated product assembly using a robot, the robot grasps a supplied component and installs the grasped component to a workpiece. There are cases where the components supplied to the robot do not have accurately determined positions and postures. In such a case, for example, after the robot grasps a component and carries the component to the front of a camera, the robot is stopped, and the component (the object to be photographed) is photographed by the camera to recognize the position and posture of the component relative to the workpiece on the basis of the obtained image. Then, based on the recognized position and posture, the position and posture of a robot hand are changed or the component is re-grasped so as to change the position and posture of the component to the position and posture that allow the component to be installed to the workpiece and then the assembly operation is performed.

Further speedup of the automated assembly operation is effectively achieved by reducing the time required for decelerating, stopping, starting and accelerating the robot. Therefore, directly photographing a component that moves at a high speed, i.e. moving object photographing, without stopping the transfer of a component by a robot at the front of a camera is preferable. To sharply photograph a moving component by the moving object photographing, the position at which the component is desirably photographed (hereinafter referred to as “the desired photographing position”) is set in advance and a lighting device and a camera are installed such that a sharp image of the component can be obtained at the desired photographing position. Then, a photographing trigger must be supplied to the camera at a timing at which the component actually passes through the desired photographing position.

For carrying out the moving object photographing described above, there has been known an imaging device adapted to continuously photograph a component being carried by a conveyor in front of a camera by photographing triggers at predetermined intervals, which are generated in the camera (refer to Japanese Patent Laid-Open No. H09-288060 (hereinafter referred to as “Patent Literature 1)). The imaging device is adapted to use a desired photographing position as the center of a screen and selects, among photographed images, the image in which the component is closest to the center of the screen as a best image and output the selected image. Hence, the imaging device stores in a memory a latest photographed image and a photographed image immediately preceding the latest photographed image, and based on the amounts of deviations of the position of the component from the center of the screen that have been calculated on the two images, the imaging device determines whether to continue photographing by suspending the determination on whether the latest image is the best or the immediately preceding image is the best.

If it is determined that the latest image is the best, then it means that the amount of deviation is below a predetermined threshold value, i.e. the component is sufficiently close to the center of the screen. If it is determined that the immediately preceding image is the best, then it means that the amount of deviation of the latest image is larger than the amount of deviation of the immediately preceding image, i.e. the component approaching the center of the screen has passed through the center and is beginning to leave the center. If the determination is suspended and the photographing is continued, then it means that it has been determined that neither the latest image nor the immediately preceding image is best.

However, according to the imaging device described in Patent Literature 1, the photographing is carried out in response to the photographing triggers issued at the predetermined intervals. Therefore, if an object, namely, a component, passes through a desired photographing position between the predetermined intervals, then a best image of the component cannot be captured. A difference between the timing at which the component passes through the desired photographing position and the timing at which the component is photographed at a photographing position closest thereto may be half the time of the interval between the photographing triggers at a maximum. Thus, if the component moves at a high speed, then the component may be photographed at a position that is far apart from the desired photographing position, posing a problem in that the positional relationship between the component and the lighting device is disturbed with a resultant failure of obtaining a sharp image.

Further, the imaging device needs to have an imaging area that is larger than an actual component because of the possibility of photographing the component located at a position deviated from a desired photographing position. This has been posing a problem of requiring an increased image size, which leads to longer time required for capturing an image, transmitting the image and processing the image, resulting in a slower automated assembly operation.

### SUMMARY OF THE INVENTION

An object of the present invention is to provide an image photographing method and an image photographing device that make it possible to photograph, at a desired photographing position, a moving object to be photographed without increasing the size of an image to be processed.

To this end, one aspect of the present invention provides an image photographing method for an image photographing device which has a camera unit capable of photographing a movable object to be photographed by switching between at least two different image qualities and a camera controller which controls the camera unit to photograph the object to be photographed. The image photographing method includes a first photographing step in which the camera controller carries out continuous photographing in a first image quality. The method includes an estimation calculation step in which the camera controller estimates a timing at which the object to be photographed passes through a predetermined desired position range on the basis of a plurality of positions of the object to be photographed, which are obtained from images photographed in the first photographing step. Furthermore, the method includes a second photographing step in which the camera controller carries out photographing at the passing timing in a second image quality, which is finer than the first image quality.

Further, the image photographing device according to another aspect of the present invention includes: a camera unit and a camera controller. The camera unit has a photographing optical system and an image sensor and is capable of photographing a movable object to be photographed by switching between at least two different image qualities. The camera controller controls the camera unit to photograph the object to be photographed. The camera controller carries out continuous photographing in a first image quality, estimates a timing at which the object to be photographed passes through a predetermined desired position range on the basis of a plurality of positions of the object to be photographed, which are obtained from photographed images, and carries out photographing at the passing timing in a second image quality, which is finer than the first image quality.

Further features of the present invention will become apparent from the following description of exemplary embodiments with reference to the attached drawings.

### BRIEF DESCRIPTION OF THE DRAWINGS

FIG. 1 is an explanatory diagram illustrating a schematic configuration of a robot apparatus according to a first embodiment of the present invention.

FIG. 2 is a block diagram illustrating an image photographing device and a controller of the robot apparatus according to the first embodiment of the present invention.

FIG. 3 is an explanatory diagram illustrating a photographic field of view in the image photographing device of the robot apparatus according to the first embodiment of the present invention.

FIG. 4 is a flowchart illustrating the procedure for photographing a workpiece by the image photographing device of the robot apparatus according to the first embodiment of the present invention.

FIGS. 5A, 5B, 5C, 5D, 5E and 5F present plan views illustrating the positional relationships between the workpiece and the photographic field of view in the image photographing device according to the first embodiment of the present invention, wherein FIG. 5A to FIG. 5E illustrate states in which the workpiece gradually enters into the photographic field of view and FIG. 5F illustrates a state in which the workpiece lies at an estimated position at an estimated time.

FIGS. 6A, 6B, 6C, 6D, 6E and 6F illustrate the images obtained by binarizing the images captured in FIG. 5A to FIG. 5E, respectively, and FIG. 6F illustrates a partial readout region in the photographic field of view when the workpiece lies at an estimated position at an estimated time.

FIG. 7 provides graphs illustrating the procedure for determining interpolating straight lines from a plurality of positions of the workpiece, determining an estimated time from a desired x-axis coordinate, and determining an estimated y-axis coordinate from the estimated time.

FIG. 8 is a block diagram illustrating an image photographing device and a controller of a robot apparatus according to a second embodiment of the present invention.

FIGS. 9A, 9B, 9C, 9D, 9E and 9F provide plan views illustrating the positional relationships between a workpiece and the photographic field of view in the image photographing device according to the second embodiment of the present invention, wherein FIG. 9A to FIG. 9E illustrate states in which a workpiece gradually enters into the photographic field of view and FIG. 9F illustrates a state in which the workpiece lies at an estimated position at an estimated time.

FIGS. 10A, 10B, 10C, 10D and 10E illustrate binarized results based on the differences among the images captured in FIG. 9A to FIG. 9E, respectively.

### DESCRIPTION OF THE EMBODIMENTS

Preferred embodiments of the present invention will now be described in detail in accordance with the accompanying drawings.

### First Embodiment

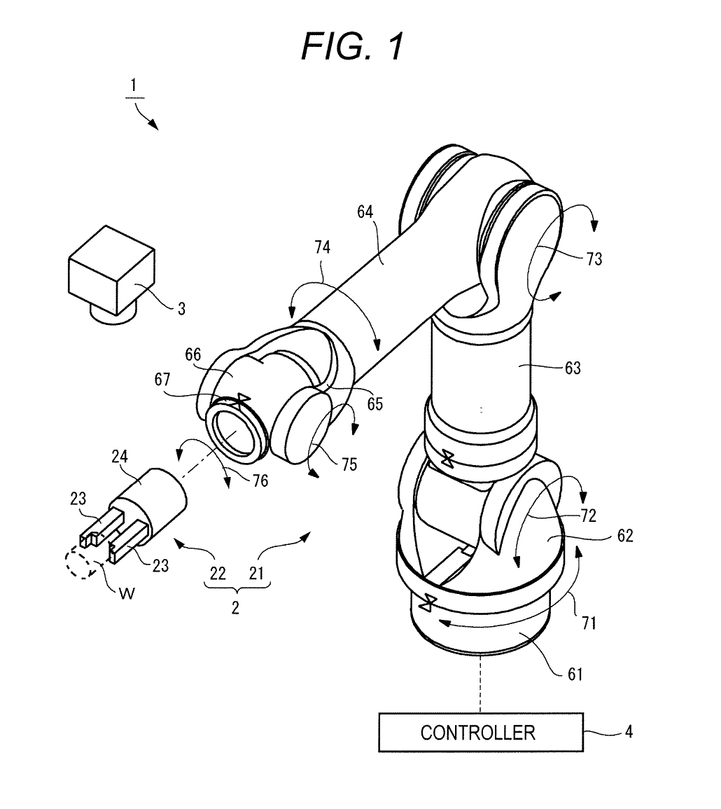

As illustrated in FIG. 1, a robot apparatus 1 serving as a production system includes a robot main body 2 as a production device, an image photographing device 3 capable of photographing from above a workpiece W, which is an object to be photographed, and a controller 4 which controls the robot main body 2 and the image photographing device 3. In the present embodiment, the robot main body 2 is capable of grasping the workpiece W and carrying the workpiece W along a pre-taught track in a working area of 500 mm×500 mm at a speed of 2000 mm/sec at a maximum.

The robot main body 2 is formed of a multi-joint robot having a 6-axis vertical multi-joint arm (hereinafter referred to as “the arm”) 21 and a hand 22 functioning as a grasping tool, which is an end effector. The present embodiment uses the 6-axis vertical multi-joint arm as the arm 21; however, the number of the axes may be changed as appropriate according to an application or purpose. Further, the present embodiment uses the hand 22 as the end effector, but the end effector is not limited thereto and may include general tools capable of grasping or holding and moving the workpiece W.

The arm 21 has seven links 61 to 67 and six joints 71 to 76, which swingably or rotatably connect the links 61 to 67. The links 61 to 67 have fixed lengths. However, the links that are extendable by, for example, a direct acting actuator may alternatively be used. Each of the joints 71 to 76 has a motor that drives each of the joints 71 to 76, an encoder that detects the rotational angle of the motor, a current sensor that detects the current supplied to the motor, and a torque sensor that detects the torque of each of the joints 71 to 76.

The hand 22 is attached to and supported by the distal link 67 of the arm 21 and adapted to be adjusted by at least one freedom degree of the position and the posture thereof by the operation of the arm 21. The hand 22 has two fingers 23 and a hand main body 24, which supports the fingers 23 such that the interval between the fingers 23 can be increased or decreased. The workpiece W can be grasped by a closing operation, in which the fingers 23 approach to each other.

The hand main body 24 includes a motor for operating the fingers 23, an encoder that detects the rotational angle of the motor, and a joining portion to be connected to the distal link 67. In the present embodiment, the hand 22 has two fingers 23; however, the number of the fingers 23 is not limited thereto and may be two or more to grasp the workpiece W.

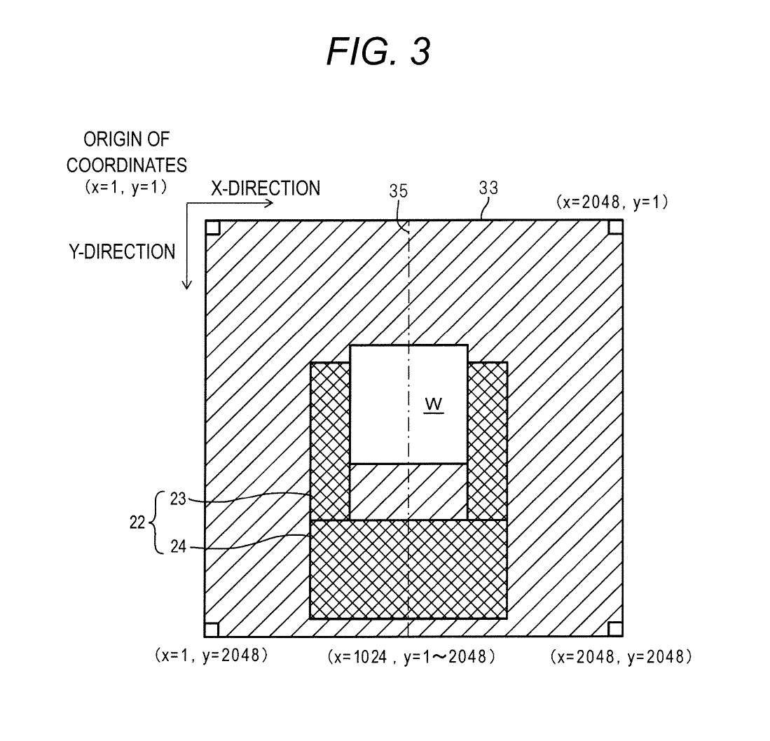

As illustrated in FIG. 3, at least the side surface of the hand 22, which side is to be photographed by the image photographing device 3, is painted with a color of low brightness, such as black. The photographing background of the hand 22 photographed by the image photographing device 3 is also painted with a color of low brightness, such as black. The color of at least the side surface of the hand 22, which is photographed by the image photographing device 3, is not limited to black, and does not have to be black as long as the color has a sufficient difference relative to the brightness of the workpiece W, as will be discussed hereinafter. Although FIG. 3 does not illustrate the arm 21, it is obvious that the arm 21 actually supports the hand 22.

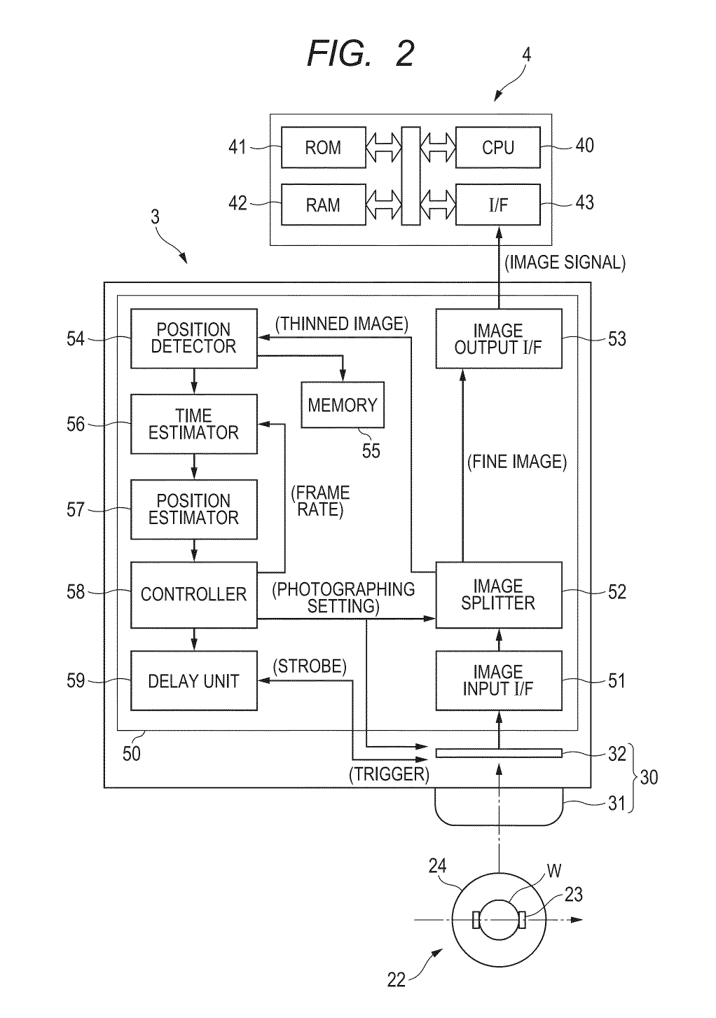

As illustrated in FIG. 2, the controller 4 is composed of a computer to control the robot main body 2 and the image photographing device 3. The computer constituting the controller 4 includes, for example, a CPU 40, a ROM 41 that stores programs for controlling each section, a RAM 42 that temporarily stores data, and an input/output interface circuit (I/F) 43.

In the present embodiment, the workpiece W is a component constituting a product and measures, for example, approximately 50 mm×50 mm square, as observed from above. The workpiece W is placed on a pallet without being accurately positioned, and picked up by the hand 22 and carried to a predetermined position for assembling the product. When the workpiece W is picked up by the hand 22, the position and posture of the workpiece W are unknown. For this reason, a fine image is photographed by the image photographing device 3 and then the position and posture are measured by image processing carried out by the controller 4. Thereafter, the position and posture are corrected by the arm 21 before the workpiece W is, for example, attached to another workpiece.

As illustrated in FIG. 3, the workpiece W has a color of high brightness, such as white, in the present embodiment. In the image taken by the image photographing device 3, therefore, the workpiece W is clearly recognized against the hand 22 and the photographing background, which are black. However, the color of the workpiece W is not limited to white and may not be white as long as the color has a sufficient difference relative to the brightness of the workpiece W and the photographing background.

With reference to FIG. 2, a detailed description will now be given of the image photographing device 3, which is a characteristic aspect of the present embodiment. The image photographing device 3 is disposed apart from the robot main body 2 and, for example, fixed on and supported by a mount which is supported by a base. The image photographing device 3 includes a camera 30 that photographs the workpiece W and a camera controller 50 that controls the camera 30 to acquire and process image data.

The camera 30 has a lens 31 as a photographing optical system and an image sensor 32 that captures an image from the lens 31 and converts the image into an electrical signal. The optical system combining the lens and the image sensor 32 is adapted to have a photographic field of view 33 of 100 mm×100 mm (refer to FIG. 3).

The image sensor 32 uses, for example, a CMOS image sensor, but is not limited thereto. The image sensor 32 may alternatively use a CCD sensor or the like. The image sensor 32 has a space resolution of approximately 4 mega pixels (2048×2048 pixels). Each pixel has a bit depth of 8 bits, and an image is output by ten pairs of LVDS signals. In other words, the pixel resolution of the photographing optical system is approximately 50 μm×50 μm. The frame rate for outputting 4 mega pixels by the image sensor 32 is, for example, 160 fps.

As illustrated in FIG. 3, the coordinate system of the photographic field of view 33 is created on an image area of 2048×2048 pixels that can be photographed by the image photographing device 3, and the horizontal rightward direction of the image area is defined as x-direction, while the vertical downward direction thereof is defined as y-direction. An origin of the coordinates (x=1, y=1) is a top left point of the image area. Further, a top right point of the image area is defined by (x=2048, y=1), a bottom left point is defined by (x=1, y=2048), and a bottom right point is defined by (x=2048, y=2048).

The image sensor 32 writes a set value to a built-in register and reads out a fine image of approximately 4 mega pixels through communication, such as a serial peripheral interface (SPI). The image sensor 32 is capable of reading out a thinned image of a low image (a first image quality) obtained by thinning an image by a thinning amount, such as ½×½ (skipping 1 pixel) or ¼×¼ (skipping 3 pixels), according to the set value written to the built-in register. The frame rate can be sped up according to the thinning amount. For example, in the case of the thinning of ¼×¼, the frame rate will be, for example, 2560 fps, which is 16 times higher.

Further, the photographing mode of the image sensor 32 can be switched between a continuous photographing mode for continuously photographing images at a constant frame rate and a trigger photographing mode for photographing a single image by using an external trigger. The image sensor 32 also has a partial readout function for specifying a rectangular region to be actually read from among the effective pixels of 2048×2048 pixels. When the partial readout function is enabled, the frame rate becomes faster according to the number of pixels in the readout range.

The image sensor 32 incorporates a Bayer RGB color filter. For example, if a photographed image is thinned by ¼×¼ (vertically and horizontally skipping 3 pixels), then an image having all its pixels subjected to the R (red) color filter will be obtained. In the image sensor 32, a vertical synchronization signal remains High during the transmission of a signal in each photographing frame.

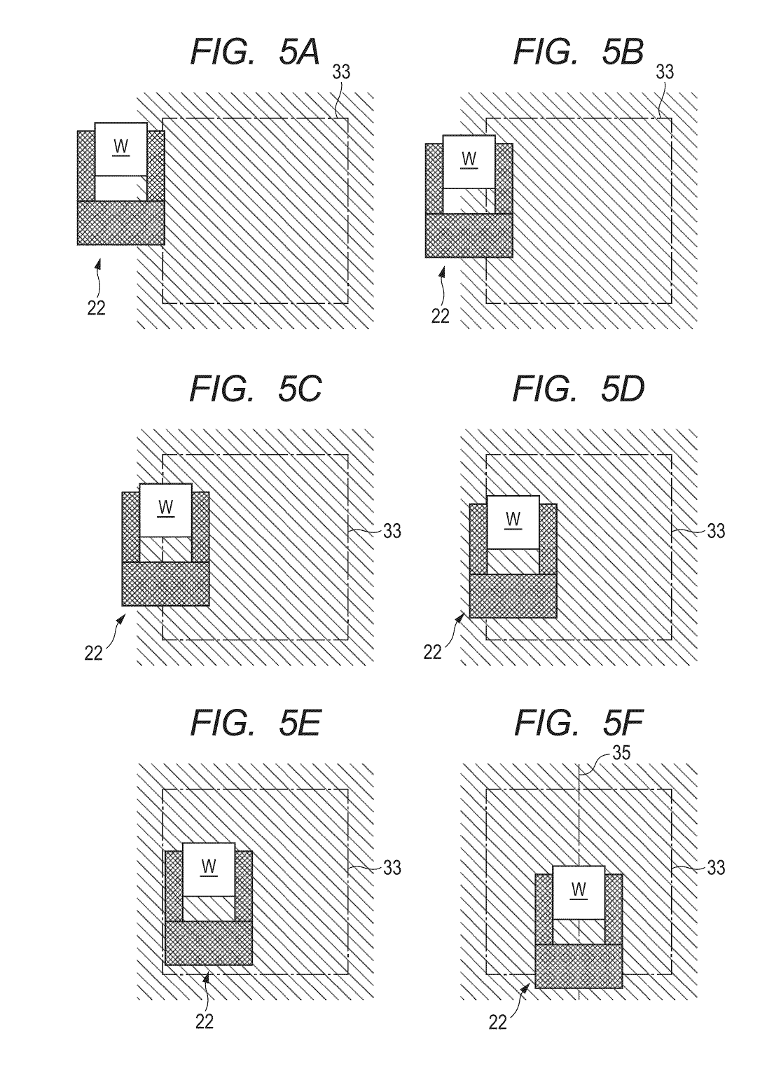

In the present embodiment, a controller 58, which will be discussed hereinafter, writes a set value, which specifies the thinned readout of ¼×¼ and the continuous photographing mode, to the register of the image sensor 32 and then stands by in a high-speed photographing state. This photographing mode is referred to as “the moving image photographing” in the present embodiment. For example, as illustrated in FIG. 5A to FIG. 5E, in the case of photographing in the moving image photographing mode, continuous photographing is carried out at regular time intervals determined according to a frame rate.

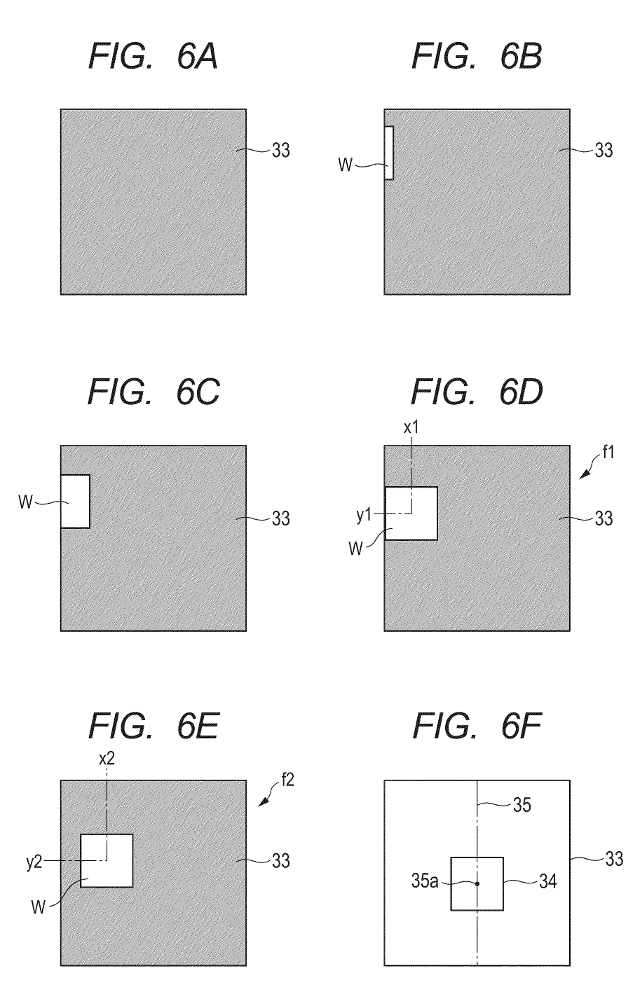

When the workpiece W enters the photographic field of view 33, the camera controller 50 calculates the timing for photographing fine images and photographing positions. Then, the controller 58 clears the setting for thinning and specifies the partial readout region 34 (refer to FIG. 6F) thereby to write a set value that specifies the trigger photographing mode to the register of the image sensor 32. The controller 58 sets the image sensor 32 to wait for a photographing trigger. Upon the receipt of the trigger, one fine image of thinning-free high image quality (a second image quality) is photographed. In the present embodiment, the photographing mode is referred to as “the trigger photographing mode.” In other words, the camera 30 is capable of photographing the workpiece W by switching between at least two different image qualities.

As illustrated in FIG. 2, the thinned image and the fine image obtained by the image sensor 32 are both output to an image input interface (I/F) 51, which will be discussed hereinafter.

The camera controller 50 includes the image input interface 51, an image splitter 52, an image output interface (I/F) 53, a position detector 54, an internal memory 55, a time estimator 56, a position estimator 57, the controller 58, and a delay unit 59. These are mounted on an electronic circuit board incorporated in the camera controller 50. The image splitter 52, the position detector 54, the internal memory 55, the time estimator 56, the position estimator 57, the controller 58, and the delay unit 59 are installed in the form of an arithmetic block in a field-programmable gate array (FPGA) device mounted on the electronic circuit board. The arithmetic block includes a synthesis circuit based on the hardware description in the widely known HDL language and a macro circuit of the FPGA.

In the present embodiment, the image input interface 51 and the image output interface 53 are installed separately from the FPGA. Alternatively, however, these interfaces 51 and 53 may be installed in the FPGA. Further, the FPGA constitutes the arithmetic block in the present embodiment; however, arithmetic block is not limited thereto. Alternatively, for example, a computer (including a CPU, an MPU and the like), which is run by a program, or an application specific integrated circuit (ASIC), for example, may be used. These configurations may be designed, as appropriate, taking into account the balance among circuit areas, cost and performance, including calculation speed.

The image input interface 51 uses a widely known deserializer IC, which converts a low voltage differential signaling (LVDS) signal received from the image sensor 32 into a parallel signal, which is easy to handle in an electronic circuit. A deserializer IC capable of receiving ten differential pairs of the LVDS signals is used. A plurality of deserializers IC, each of which receives less differential pairs, may be arranged in parallel for use, as necessary. In the present embodiment, the outputs of the image input interface 51 include a parallel signal of 80 bits (8 bits×10 TAP), a pixel clock signal, a horizontal synchronization signal and a vertical synchronization signal, and are supplied to the image splitter 52. Alternatively, instead of using the foregoing deserializer IC, the LVDS signals may be supplied to a widely known FPGA device, which is capable of receiving LVDS signals, to convert the LVDS signals into parallel signals.

The image splitter 52 is an arithmetic block installed in the FPGA device mounted on the electronic circuit board. The image splitter 52 outputs the parallel signal, the pixel clock signal, the horizontal synchronization signal and the vertical synchronization signal, which are received from the image input interface 51, to the image output interface 53 or the position detector 54 according to the photographing setting received from the controller 58. The photographing setting is denoted by a 1-bit signal, which is set to “0” when an image to be photographed is a thinned image or “1” when the image to be photographed is a fine image. For example, if the photographing setting is “0,” then the parallel signal, the pixel clock signal, the horizontal synchronization signal, and the vertical synchronization signal are output to the position detector 54, and if the photographing setting is “1,” then the signals are output to the image output interface 53.

The image output interface 53 uses a widely known serializer IC which converts the 80-bit parallel signal, the pixel clock signal, the horizontal synchronization signal, and the vertical synchronization signal received from the image splitter 52 into LVDS video signals of Camera Link or the like. Alternatively, an FPGA device capable of outputting LVDS signals may be used to convert the parallel signal into a serial signal within the FPGA. The LVDS signals output from the image output interface 53 are input to the controller 4 and received by an external Camera Link grabber board or the like to carry out image processing by the CPU 40 or the like.

The position detector 54 is an arithmetic block installed in the FPGA device mounted on the electronic circuit board. The position detector 54 detects the position of the workpiece W on the image by carrying out calculation based on a movement path according to the image signal composed of the 80-bit parallel signal, the pixel clock signal, the horizontal synchronization signal, and the vertical synchronization signal received from the image splitter 52. The specific calculation method will be discussed hereinafter. The position detector 54 outputs the detected x-coordinate and y-coordinate of the centroid of the image of the workpiece W to the time estimator 56.

The internal memory 55 has a small capacity for storing the x-coordinates and the y-coordinates of the centroid of the image of the workpiece W detected by the position detector 54 for, for example, two frames.

The time estimator 56 is an arithmetic block installed in the FPGA device mounted on the electronic circuit board. The time estimator 56 estimates the time (timing) at which the workpiece W will reach a desired photographing position 35a (refer to FIG. 6F) on the basis of the x-coordinate and the y-coordinate of the centroid of the image of the workpiece W received from the position detector 54 and the frame rate value received from the controller 58.

The controller 58 is an arithmetic block installed in the FPGA device mounted on the electronic circuit board. The controller 58 instructs beforehand, to the image sensor 32, the thinning setting of ¼×¼ and the continuous photographing setting free of an external trigger through an SPI interface to set the moving image photographing mode. Further, the controller 58 outputs “0” as the photographing setting to the image splitter 52 and waits for an input from the position estimator 57, which input is received upon the appearance of the workpiece W in a photographic field of view.

When the workpiece W appears in the photographic field of view 33 and the estimated time and the x-coordinate and the y-coordinate of the centroid of the image of the workpiece W are received from the position estimator 57, the controller 58 operates as follows. First, the controller 58 instructs the image sensor 32 to clear the moving image photographing mode and set the trigger photographing mode based on external triggers through the SPI interface. Then, the controller 58 specifies a range, which has the same size as the size of the workpiece W, in the image centering about the x-coordinate and the y-coordinate of the centroid of the image of the workpiece W, as the region of interest (ROI) and sets this ROI as the readout range of the image sensor 32. Further, the controller 58 outputs “1” as the photographing setting to the image splitter 52 and outputs the estimated time to the delay unit 59.

The delay unit 59 is an arithmetic block installed in the FPGA device mounted on the electronic circuit board. The delay unit 59 has a timer therein and receives strobe signals from the image sensor 32 and an estimated time from the controller 58. Based on the last received strobe signal, the delay unit 59 waits until the received estimated time and outputs a trigger signal to the image sensor 32 when the estimated time is reached.

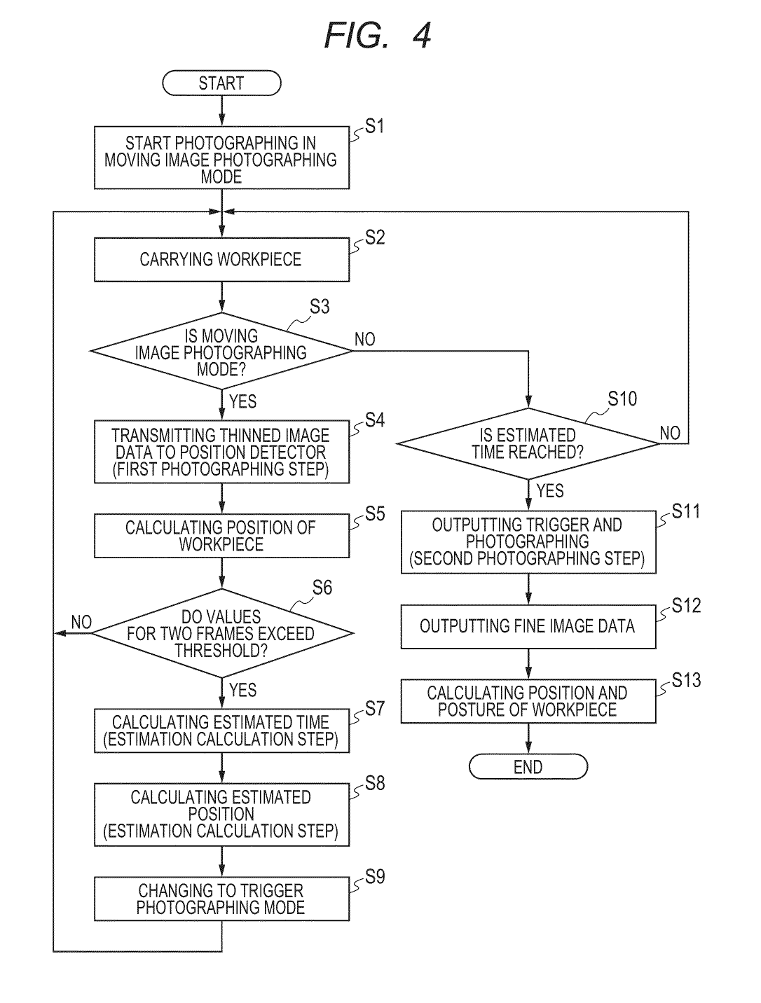

Referring now to the flowchart given in FIG. 4, a description will be given of the procedure of the operation for photographing the workpiece W by the image photographing device 3 and calculating the position and posture thereof when the workpiece W is grasped and carried by the robot apparatus 1 in the present embodiment.

Before carrying the workpiece W, the robot main body 2 is taught in advance. In this case, the robot main body 2 is taught to grasp the workpiece W by the hand 22 and carry the workpiece W such that the workpiece W passes through the photographic field of view 33 of the image photographing device 3 on a straight line at a constant speed. The robot main body 2 is taught to operate the hand 22 such that the workpiece W moves through the photographic field of view 33 substantially in the horizontal direction (x-direction), then an image is photographed at the instant the workpiece W reaches the central position in the horizontal direction in the photographic field of view 33.

In the present embodiment, the hand 22 holding the workpiece W is moved through the photographic field of view 33 at the constant speed of 2000 mm/sec, and the workpiece W passes through the vicinity of the center of the photographic field of view 33, the moving direction being close to the x-direction in the photographic field of view 33. In other words, the workpiece W appears at the left end (x=1) of the photographic field of view 33, linearly moves substantially in the x-direction and disappears at the right end (x=2048) of the photographic field of view 33.

As illustrated in FIG. 6F, the desired photographing position 35a used for the estimation by the time estimator 56 is a target point at which the centroid of the image of the workpiece W is expected to reach at a predetermined timing, and the desired photographing position 35a is to lie on a desired position range 35. As illustrated in FIG. 3, the desired position range 35 is a straight line in the y-direction, the x-coordinate being 1024 and the y-coordinate ranging from 1 to 2048. The desired position range 35 is a line in the y-direction passing through the central point of the photographic field of view 33 (x-coordinate).

If, for example, each workpiece W is placed in one section in a tray divided into a plurality of sections, meaning that the supply position of each workpiece W is different, then even when the workpiece W reaches the desired position range 35, the position at which the hand grasps the workpiece W is different each time. Therefore, the track along which the hand 22 grasps the workpiece W and moves to an assembly destination is not necessarily fixed. Hence, the position of the workpiece W in the y-direction varies when the workpiece W reaches the desired position range 35. In order to photograph the workpiece W in an appropriate image region centering around the position of the workpiece W to read the position data, the position of the workpiece W in the y-direction is estimated so as to estimate the desired photographing position 35a of one point. The position in the y-direction when the workpiece W reaches the desired position range 35 in the photographic field of view 33, i.e. the desired photographing position 35a, is estimated by the position estimator 57, as will be discussed hereinafter.

When the operation of the robot apparatus 1 is started, the controller 58 sets the image sensor 32 to the moving image photographing mode through communication, such as the SPI, and starts photographing (step S1). The controller 58 outputs a signal indicating that the image sensor 32 is in the moving image photographing mode to the image splitter 52. Thus, the controller 58 supplies, to the image splitter 52, a control signal for splitting the image, which has been photographed by the image sensor 32 in the moving image photographing mode and received from the image input interface 51, to the position detector 54. Further, the controller 58 outputs the frame rate of the image sensor 32 to the time estimator 56 so as to allow the time estimator 56 to use the value of the frame rate for the calculation for the estimation.

When the photographing is started, the robot main body 2 carries the workpiece W (step S2). During the transfer of the workpiece W, the processing by the image photographing device 3 varies depending on the photographing mode (step S3). If the photographing mode is the moving image photographing mode, then the image sensor keeps on continuously photographing thinned images throughout the photographic field of view 33 and transmits the data to the position detector 54 according to the following procedure (step S4, a first photographing step) until the photographing mode is changed.

First, the images photographed by the image sensor 32 are sequentially output in the form of, for example, LVDS signals, to the image input interface 51. At this time, the LVDS signals are transmitted by, for example, ten pairs of differential signal lines, and each of the differential signal lines outputs a serial signal that has been serialized by sevenfold multiplication of frequency. At the same time, the image sensor 32 outputs a strobe signal generated for each photographing to the delay unit 59 to make the strobe signal function as a reference signal for generating a photographing trigger, which is used for photographing a fine image later, at an accurate timing.

The image input interface 51 sequentially converts the thinned images, which have been sequentially input as the LVDS signals from the image sensor 32, into image data of parallel signals and supplies the image data to the image splitter 52. The image splitter 52, which has already received from the controller 58 the signal indicating that the image sensor 32 is in the moving image photographing mode, sequentially outputs the image data obtained in the moving image photographing mode to the position detector 54.

The position detector 54 calculates and detects the position at which the workpiece W lies in the thinned image that has been received (step S5). In the present embodiment, the position detector 54 calculates the x-coordinate and the y-coordinate of the centroid of the image of the workpiece W to detect the position at which the workpiece W lies in the image. The calculation method will be described below in detail.

In the present embodiment, the hand 22 and the photographing background are black, while the workpiece W is white, so that the image signals input to the position detector 54 will provide the images illustrated in FIGS. 5A to 5F. The position detector 54 binarizes the input parallel image signals for each 8 bits, which means one pixel. In the binarization, the pixel value is High (1) if the value exceeds a predetermined threshold value (e.g. 128) or Low (0) if the value is the threshold value or less. The images illustrated in FIG. 5A to FIG. 5E are binarized into the images illustrated in corresponding FIG. 6A to FIG. 6E. In the present embodiment, however, the binarization is carried out by pipeline processing at pixel level, so that the group of binarized images, as illustrated in FIG. 6A to FIG. 6E, will not be stored or output.

The method for calculating the centroid of a binarized image having a pixel value (brightness value) of 0 or 1 will now be described. The centroid of an image generally denotes the central coordinate of mass distribution when a brightness value is regarded as a mass, and becomes the central coordinate of a plurality of pixels, the brightness values of which are 1, in a binarized image. Further, to calculate the centroid of the image, a zero-order moment and a first-order moment of the image are used. An image moment generally denotes a gravitational moment when a brightness value is regarded as a mass. The zero-order moment in the binarized image denotes the sum total of the number of pixels whose brightness values are 1, while the first-order moment in the binarized image denotes the sum total of the positional coordinate values of pixels whose brightness values are 1. In the present embodiment, the first-order moment of the image calculated in the x-direction is referred to as the horizontal first-order moment of the image, while the first-order moment of the image calculated in the y-direction is referred to as the vertical first-order moment. The x-coordinate of the centroid of the image can be calculated by multiplying the horizontal first-order moment of the image by the reciprocal of the zero-order moment of the image. The y-coordinate of the centroid of the image can be calculated by multiplying the vertical first-order moment of the image by the reciprocal of the zero-order moment of the image.

Based on the above, the zero-order moment of the image, the horizontal first-order moment of the image, and the vertical first-order moment of the image are calculated on an obtained binary signal. The position detector 54 has a horizontal coordinate register, a vertical coordinate register, a zero-order moment register, a horizontal first-order moment register, and a vertical first-order register in a calculation block of the FPGA. The horizontal coordinate register is incremented in synchronization with the pixel clock and reset in synchronization with a horizontal synchronization signal. The vertical coordinate register is incremented in synchronization with the horizontal synchronization signal and reset in synchronization with the vertical synchronization signal. The zero-order moment register retains the cumulative value of the zero-order moments of the image. The horizontal first-order moment register retains the cumulative value of the horizontal first-order moments of the image. The vertical first-order moment register retains the cumulative value of the vertical first-order moments of the image.

Each register retains zero as an initial value. When a 1-bit binary image signal is input first, a 1-bit value is added to the value of the zero-order moment register. Further, (the bit value×(the value of the horizontal coordinate register)×4) is calculated and the calculation result is added to the value of the horizontal first-order moment register. Further, (the bit value×(the value of the vertical coordinate register)×4) is calculated and the calculation result is added to the value of the vertical first-order moment register.

The calculation described above is repeated for the number of all pixels (2048×2048 pixels) in synchronization with the pixel clock. Thus, the zero-order moment of the image, the horizontal first-order moment of the image, and the vertical first-order moment of the image of the entire thinned image are stored in the zero-order moment register, the horizontal first-order moment register, and the vertical first-order moment register, respectively.

Next, based on the zero-order moment of the image, the horizontal first-order moment of the image, and the vertical first-order moment of the image, which have been calculated, the centroid of the image is calculated. The x-coordinate of the centroid of the image is hardware-calculated according to an expression of (the horizontal first-order moment register value/zero-order moment register value). The y-coordinate of the centroid of the image is hardware-calculated according to an expression of (the vertical first-order moment register value/zero-order moment register value).

The x-coordinate and the y-coordinate of the centroid of the image of the workpiece W calculated as described above are output from the position detector 54 and supplied to the time estimator 56. If the workpiece W does not exist in the photographic field of view, then the position detector 54 outputs “0” as the horizontal coordinate and the vertical coordinate of the centroid of the image of the workpiece W.

Of the calculations described above, the binarization processing of the pixels and the cumulative calculation for calculating the zero-order moment of the image, the horizontal first-order moment of the image and the vertical first-order moment of the image are carried out by pipeline processing. More specifically, for example, instead of waiting until the binarization processing of all pixels is completed, the cumulative calculation on a first pixel is carried out while the binarization processing is being carried out on a second pixel at the same time, and the cumulative calculation on the second pixel is carried out while the binarization processing is being carried out on a third pixel at the same time.

In the description of the present embodiment, as the method for detecting the position of the workpiece W from a thinned image, the method in which the image is binarized and the zero-order moment of the image, the horizontal first-order moment of the image and the vertical first-order moment of the image are calculated and then the centroid of the image is calculated has been described. The method, however, is not limited thereto. Alternatively, a widely known object detection method based on a precondition that the photographing background is black may be used. For example, a template image of the workpiece W that has a resolution corresponding to a thinned image may be stored in the FPGA beforehand and a well-known processing circuit that carries out template matching may be installed in the FPGA to detect the position of the workpiece W. If noise is mixed in an image, causing the workpiece W to be erroneously detected even when the workpiece W is not present in the photographic field of view 33, then filtering, in which, for example, an output coordinate is set to zero by using the value of the zero-order moment of the image as the threshold value, may be carried out.

Upon receipt of a frame rate from the controller 58, the time estimator 56 determines beforehand the time interval between the frames. The time interval is determined by installing a look up table (LUT), which indicates the corresponding relationship between frame rates and time intervals, in the FPGA. Alternatively, a dividing circuit may be created in the FPGA and the reciprocals of the frame rates may be calculated.

The time estimator 56 stores the x-coordinate and the y-coordinate of the centroid of the image of the workpiece W, which has been received from the position detector 54, in an internal memory 55 in the FPGA. The internal memory 55 stores coordinates for at least two frames, and when the x-coordinate and the y-coordinate of the centroid of the image of the workpiece W are written, the internal memory 55 deletes the values for one oldest frame so as to always store the values for two latest frames. In an initial state, zero “0” is stored at the x-coordinates and the y-coordinates of the centroids of the images for two frames. The storing cycle described above is repeated until the workpiece W appears in the photographic field of view 33.

Further, the time estimator 56 determines whether the retained values of both the x-coordinates and the y-coordinates of the centroids of the images of the workpiece W have exceeded a predetermined threshold value for two consecutive frames (step S6). The threshold value is a parameter for standing by until the entire workpiece W appears in the photographic field of view 33. For example, the parameter for the x-coordinate is set to half the number of pixels corresponding to the size of the workpiece W in the x-direction, and the parameter for the y-coordinate is set to half the number of pixels corresponding to the size of the workpiece W in the y-direction.

Specifically, in the states illustrated in FIG. 6A to FIG. 6C, the workpiece W has not yet completely entered the photographic field of view 33 in the x-direction, so that the x-coordinate of the centroid will be smaller than the threshold value. Meanwhile, in the states illustrated in FIG. 6D and FIG. 6E, the whole image of the workpiece W has entered the photographic field of view 33, so that the values of both the x-coordinate and the y-coordinate of the centroid exceed the threshold value.

If the time estimator 56 determines that the retained values of both the x-coordinate and the y-coordinate of the centroid of the image of the workpiece W have not yet exceeded the threshold value for two consecutive frames, then the transfer of the workpiece W and the photographing in the moving image photographing mode will be continued (step S2).

If the time estimator 56 determines that the retained values of both the x-coordinates and the y-coordinates of the centroids of the images of the workpiece W have exceeded the predetermined threshold value for two consecutive frames, then the time estimator 56 calculates the estimated time at which the workpiece W will pass through the desired position range 35 (step S7, which is an estimation calculation step). The following will describe in detail the procedure carried out by the time estimator 56 to calculate the estimated time by linear estimation, which uses the values of the positions for two frames and the time interval between the frames.

First, the x-coordinates and the y-coordinates of the centroids of the images of the workpiece W for two frames and the time interval between the frames are used to obtain the function denoting the relationship between the x-coordinate of the centroid of the image and time t and a function denoting the relationship between the y-coordinate of the centroid of the image and time t by carrying out well-known linear interpolation processing.

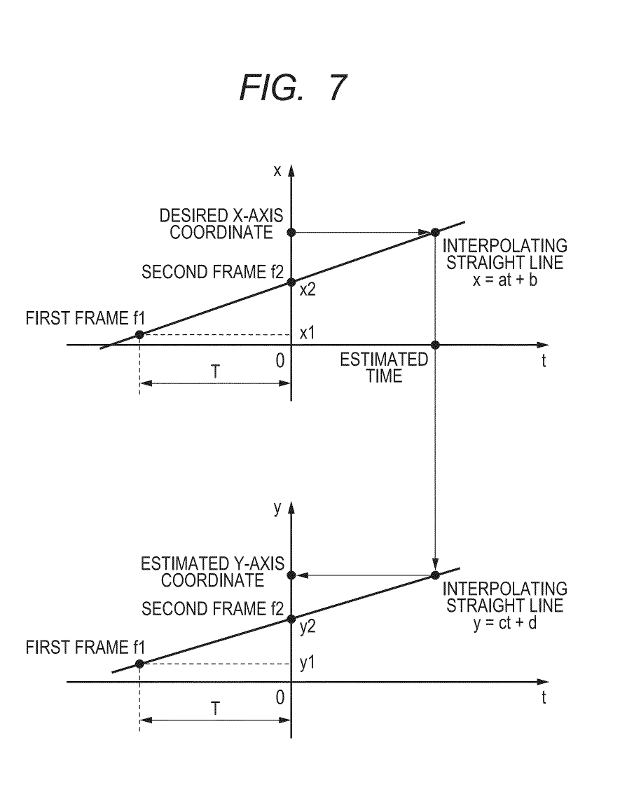

Specifically, as illustrated in FIG. 6D and FIG. 6E, the x-coordinates of the centroids of the images for two frames are defined as x1 and x2, respectively, while the y-coordinates of the centroids of the images for two frames are defined as y1 and y2, respectively. Then, as illustrated in FIG. 7, the time interval between frames is denoted by T and the time at which a second frame was photographed is denoted by time 0, i.e. t=0. Further, the function denoting the relationship between the x-coordinate of the centroid of the image of the workpiece W and time t is represented by a linear expression, x= at +b, wherein “a” denotes a slope and “b” denotes an intercept. Similarly, the function denoting the relationship between the y-coordinate of the centroid of the image of the workpiece W and time t is represented by a linear expression, y=ct+d, wherein “c” denotes a slope and “d” denotes an intercept.

According to the expressions, a, b, c and d are determined. The a, b, c and d can be determined by a=(x2−x1)/T, b=x2, c=(y2−y1)/T, and d=y2. If the x-coordinate of the desired position range 35 is defined as a desired x-axis coordinate x, then the estimated time can be calculated by t=(x−b)/a. If the desired position range 35 is taken on the y-coordinate, then the estimated time can be calculated by t=(y−d)/c.

The time estimator 56 substitutes the x-coordinate or the y-coordinate of the desired position range 35, which has been determined beforehand, into the foregoing two expressions to calculate the estimated time, and then outputs the values of a, b, c and d and the estimated time to the position estimator 57. In the present embodiment, the estimated time has been calculated by the linear interpolation by using the x-coordinates and the y-coordinates of the centroids of the images for two frames. Alternatively, however, the coordinates of the centroids for three frames or more may be used for approximation by a quadratic expression, a cubic expression, an ellipse or other types of curves. Further, as described above, if the desired position range 35 is set on the y-coordinate, then the estimated time is calculated in the same manner by using the y-coordinate of the centroid of the image. The processing described above is implemented by forming an adding circuit, a subtracting circuit, a multiplying circuit, and a dividing circuit in the FPGA.

The position estimator 57 calculates the x-coordinate and the y-coordinate of the centroid of the image of the workpiece W at the estimated time, i.e. the desired photographing position 35a, which is the estimated position, based on the values of a, b, c and d and the estimated time received from the time estimator 56 (step S8, which is the estimation calculation step). The position estimator 57 calculates the x-coordinate and the y-coordinate of the centroid of the image of the workpiece W by substituting the estimated time into time functions x=at+b and y=ct+d. The position estimator 57 outputs the estimated time and the x-coordinate and the y-coordinate of the centroid of the image of the workpiece W, which have been calculated, to the controller 58.

In the case where the desired position range 35 is set on the x-coordinate as in the present embodiment, the x-coordinate of the centroid of the image of the workpiece W calculated by the position estimator 57 is equal to the desired position range 35, so that the values may be stored beforehand in a register in the FPGA for future use. Further, if the desired position range 35 is set on the y-coordinate, then the y-coordinate of the centroid of the image of the workpiece W calculated by the position estimator 57 is equal to the desired position range 35, so that the values may be stored beforehand in the register in the FPGA for future use. The processing is implemented by forming an adding circuit and a multiplying circuit in the FPGA.

The controller 58 defines, as the ROI, a range having the same size as that in the image of the workpiece W centering around the estimated position and sets as the partial readout region 34 centering around the desired photographing position 35a of the image sensor 32, as illustrated in FIG. 6F. The controller 58 clears the moving image photographing mode and changes the mode to the trigger photographing mode for photographing fine images in synchronization with a trigger signal (step S9). Further, the signal indicating that the image sensor 32 is in the trigger photographing mode is output to the image splitter 52 and the estimated time is output to the delay unit 59.

The transfer of the workpiece W is continued thereafter (step S2), and since the photographing mode is the trigger photographing mode in step S3, the operation of the delay unit 59 is started. More specifically, when the estimated time is input from the controller 58 to the timer, the delay unit 59 waits for the input estimated time, using the strobe signal as the reference, and determines whether the estimated time is reached (step S10). If the delay unit 59 determines that the estimated time is not reached, then the transfer of the workpiece W is continued (step S2) and the delay unit 59 determines again whether the estimated time is reached (step S10).

If the delay unit 59 determines that the estimated time is reached, then the delay unit 59 outputs the trigger signal to the image sensor 32 (step S11, which is a second photographing step). Upon receipt of the trigger signal from the delay unit 59, the image sensor 32 photographs a fine image through the lens 31. At this time, the workpiece W has been moved to the estimated position, as illustrated in FIG. 5F. As illustrated in FIG. 6F, the partial readout region 34, which has already been set, enables the image sensor 32 to photograph an image of a minimum necessary size for photographing the workpiece W at the instant the moving workpiece W reaches the desired photographing position 35a. The obtained image is output to the image output interface 53 through the intermediary of the image input interface 51 and the image splitter 52.

The image output interface 53 receives the fine image in the form of a parallel signal, serializes the received image data of the parallel signal by, for example, sevenfold multiplication of frequency, and outputs the serialized data through ten pairs of differential signal lines according to a video signal standard, such as Camera Link (step S12). The output video signal is received and processed by a frame grabber board or the like of the controller 4 or the like, and based on the processing result, the controller 4 calculates the position and posture of the workpiece W (step S13).

As described above, according to the image photographing device 3 of the present embodiment, the camera controller 50 is capable of estimating the timing at which the workpiece W passes through the desired photographing position 35a on the basis of thinned images obtained by the continuous photographing, making it possible to photograph a fine image at the estimated timing. Thus, a fine image can be obtained without stopping the workpiece W. In addition, since the position of the workpiece W at the time of photographing the fine image is known, the photographing range can be narrowed to the partial readout region 34 measuring approximately the same size as the workpiece W, so that the size of the fine image can be reduced. In other words, an image size can be reduced since it is no longer necessary to photograph an image region that is larger than an actual component size to allow a margin for possible missing of an accurate photographing position especially when the workpiece W moves at a high speed. Hence, the time required for image photographing, image transmission and image processing can be shortened, leading to a faster automated assembly operation by the robot apparatus 1.

Further, according to the image photographing device 3 of the present embodiment, the time at which the workpiece W will reach the desired photographing position 35a and the position thereof on an image can be estimated, so that a photographing trigger can be generated at an accurate timing at which the workpiece W passes through the desired photographing position 35a. Hence, even if the travel distance of the workpiece W between frames is large, as in the case where, for example, the workpiece W moves at a high speed, the workpiece W can be photographed in the vicinity of the desired photographing position 35a set beforehand. Thus, the positional relationship with the lighting device will not be disturbed, allowing a sharp image to be obtained even if the workpiece W is moving fast.

### Second Embodiment

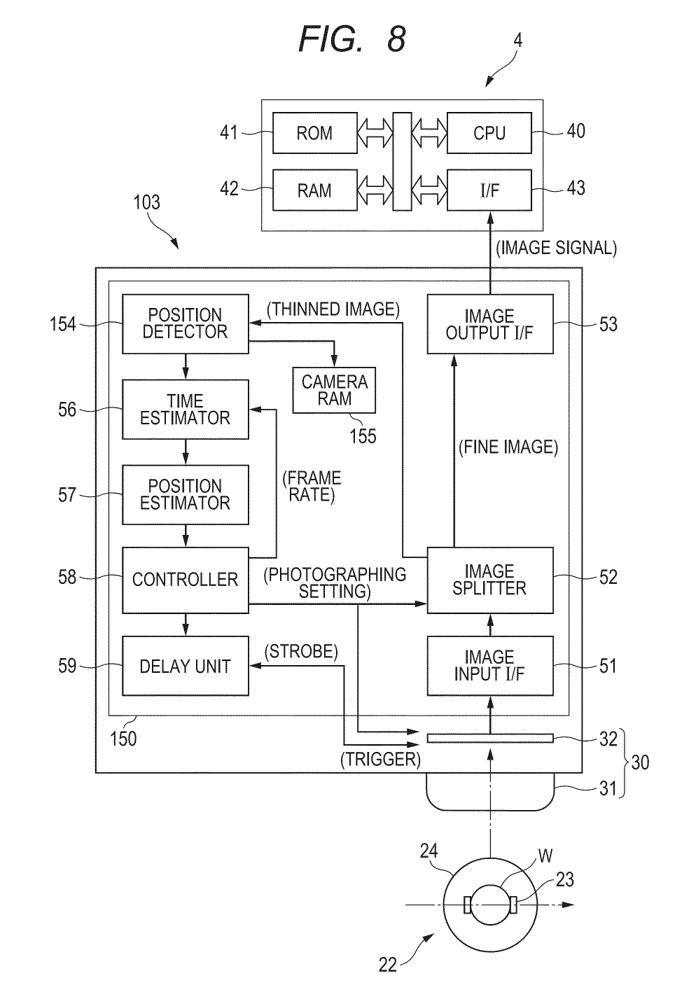

Referring now to FIG. 8 to FIG. 10E, an image photographing device 103 according to a second embodiment of the present invention will be described.

A camera controller 150 of the image photographing device 103 is different in that the built-in memory 55 in the first embodiment is omitted and a camera RAM 155, which is a memory having a larger capacity, is provided. The rest of the construction is the same as that of the first embodiment, so that the same reference numerals will be used and detailed descriptions thereof will be omitted. Further, the operation of a robot main body 2, the track of a workpiece W, the resolution of photographing, and the like are the same as those of the first embodiment.

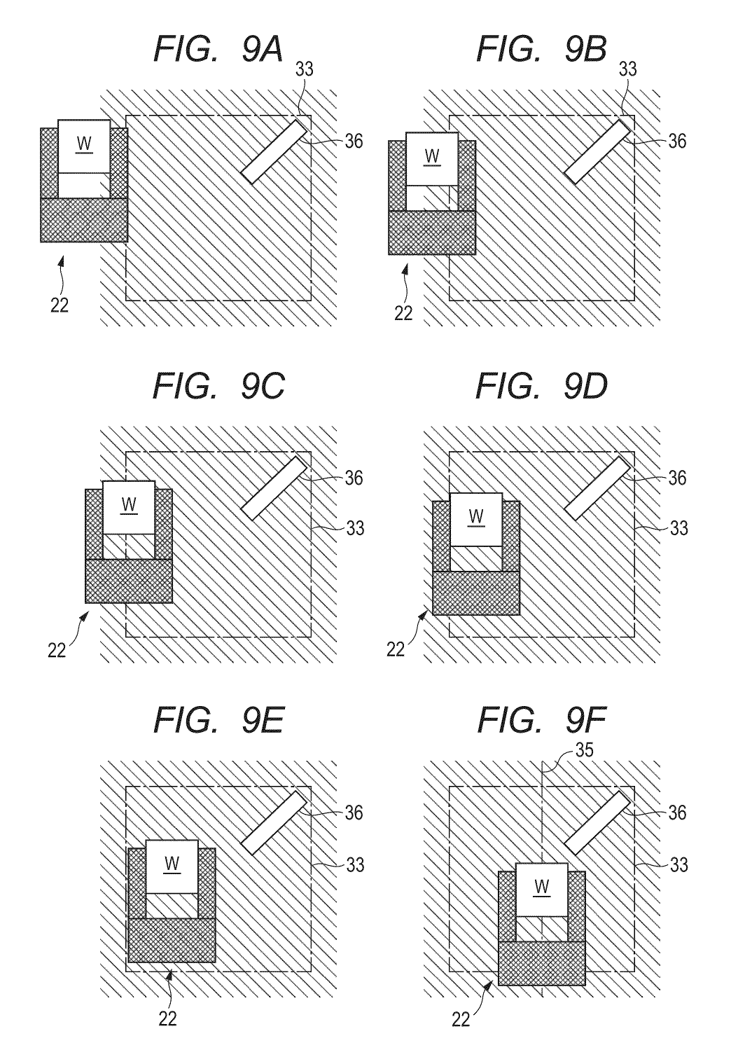

In the first embodiment, the photographing background is black. However, in the case where, for example, another workpiece is present in a photographing background, the entire photographing background cannot necessarily be set black. Even if the entire photographing background can be set black, it is possible in some cases that the photographing background cannot be set black due to, for example, the reflection of disturbance light, which causes a surface to shine and become bright. In the present embodiment, it is assumed that another workpiece 36, which is white, is observed in a photographic field of view 33, as illustrated in FIGS. 9A to 9F. In the second embodiment, therefore, the camera controller 150 is capable of removing a background.

The camera RAM 155 provided in the camera controller 150 is a RAM mounted on an electronic circuit board and includes, for example, ten 256-Kbyte SDRAMs. The bit width of each SDRAM is 8 bits. The SDRAMs are capable of specifying row addresses and column addresses and reading and writing in synchronization with synchronization signals.

A position detector 154 has a memory interface for accessing the camera RAM 155. The memory interface includes ten arithmetic blocks connected in parallel to match the ten SDRAMs. The memory interface starts memory access when a vertical synchronization signal switches to High and supplies to the SDRAMs a pixel clock signal as the synchronization signal for the memory access. Further, the memory interface increments the row address in synchronization with the pixel clock signal and increments the column address in synchronization with a horizontal synchronization signal thereby to set an address to be accessed in the SDRAMs. When the vertical synchronization signal switches to Low, the memory access is terminated. The image signal of an immediately preceding frame is stored in the camera RAM 155.

A description will now be given of the procedure of the operation for photographing the workpiece W by the image photographing device 103 of the present embodiment and calculating the position and posture thereof. Aspects that are different from the operation procedure in the first embodiment will be described in detail. The rest of the procedure is the same as that of the first embodiment, so that the description thereof will be omitted.

In step S5 of the first embodiment, the position detector 54 directly binarizes thinned images to calculate the position of the centroid of the workpiece W. Compared to this, according to the present embodiment, a position detector 154 calculates in order, for each pixel, the value of the difference between a latest image that has been photographed and just received and an immediately preceding image so as to calculate the position of the centroid of the workpiece W by using a plurality of images with the backgrounds thereof removed.

Specifically, the position detector 154 reads out and obtains an immediately preceding image from the camera RAM 155 through the memory interface in synchronization with a parallel image signal, a pixel clock signal, a horizontal synchronization signal and a vertical synchronization signal, which have been received. The position detector 154 carries out background removal processing (binarization processing) on the value of the difference of each pixel between a latest image and an immediately preceding image. In other words, corresponding pixels of two consecutive thinned images are compared in photographing brightness. The background removal processing is carried out by setting a pixel value to Low (0 denoting a first brightness) as the background brightness if the pixel value is a predetermined threshold value (e.g. 128) or less, and by setting a pixel value to High (1 denoting a second brightness) if the pixel value exceeds the threshold value.

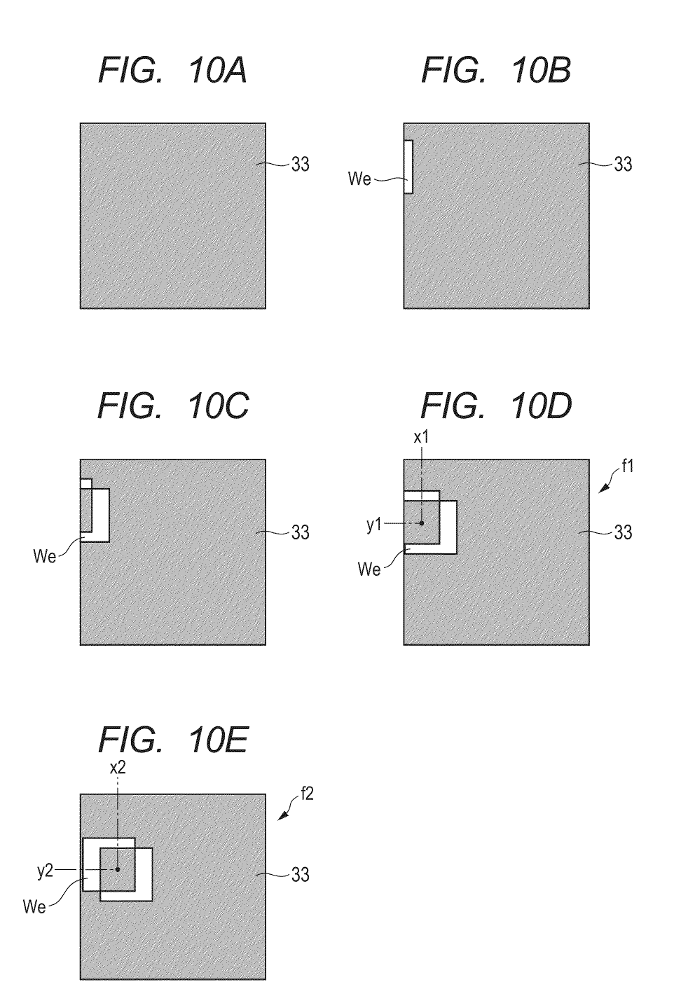

The binarized images are illustrated in FIGS. 10A to 10E. For example, the image in FIG. 10D is obtained by comparing the latest image (FIG. 9D) and the immediately preceding image (FIG. 9C) and carrying out the binarization processing on the value of the difference therebetween. In the present embodiment, the binarization is carried out by pipeline processing at pixel level, as will be discussed hereinafter, so that the group of binarized images, as illustrated in FIGS. 10A to 10E, will not be stored or output.

As in step S5 of the first embodiment, the position detector 154 calculates the zero-order moment of an image, the horizontal first-order moment and the vertical first-order moment of the image, and calculates the x-coordinate and the y-coordinate of the centroid of the image of the workpiece W.

Further, the position detector 154 overwrites, through the memory interface, the camera RAM 155 with a received parallel image signal by a pixel clock signal, a horizontal synchronization signal and a vertical synchronization signal. Thus, the thinned image for one frame (512×512 pixels) is stored in the ten SDRAMs. The stored image will be used as an immediately preceding image for the next frame.

As described above, the image photographing device 3 of the present embodiment makes it possible to generate a photographing trigger at an accurate timing at which the workpiece W will pass a desired photographing position 35a even if the photographing background of the workpiece W is bright rather than black. This makes it possible to photograph the workpiece W at the desired photographing position 35a even if the workpiece W is moving fast and also to photograph the workpiece W in the vicinity of a position set beforehand even with a device in which it is difficult to set a black background.

In the present embodiment, the description has been given of the method in which the photographing background of the workpiece W is removed by using the difference between frames; however, the method is not limited thereto, and other well-known or new background removal processing may be applied. For example, the camera RAM 155 may use a nonvolatile memory, and the workpiece W and a background image without a hand 22 included therein may be stored in the camera RAM 155 beforehand, and the difference may be calculated so as to remove the background. Further, if noise is mixed in an image, causing the workpiece W to be erroneously detected even when the workpiece W is not present in a photographic field of view 33, then filtering in which, for example, an output coordinate is set to zero by using the value of the zero-order moment of the image as the threshold value, may be carried out.

Further, regarding the image photographing device 3 in the first and the second embodiments described above, the case where the desired position range 35 is set on the y-direction line has been described; however, the setting is not limited thereto. For example, the desired position range 35 may be set on the x-direction line and the taught direction of the hand 22 may be set to the x-direction in the photographic field of view 33.

Further, regarding the image photographing device 3 in the first and the second embodiments described above, the case where the desired position range 35 is set on the y-direction line passing through the center of the photographic field of view 33 has been described; however, the setting is not limited thereto. For example, according to a lighting environment or the like, the desired position range 35 may be set on a y-direction line not passing through the center of the photographic field of view 33. In this case, the thinned images that can be used for calculating the track of the workpiece W can be increased to improve the estimation accuracy by, for example, placing the desired position range 35 on the downstream side in the direction in which the workpiece W moves relative to the center of the photographic field of view 33. This makes it possible to photograph fine images with higher accuracy.

Further, in the image photographing device 3 in the first and the second embodiments, the desired position range 35 is set on a line substantially orthogonal to the direction in which the workpiece W moves; however, the desired position range 35 is not limited thereto, and may alternatively be circular, rectangular or the like that has a width in the direction in which the workpiece W moves. In this case, the desired photographing position may be any position insofar as it is within the desired position range, and a plurality of fine images can be photographed within the desired position range.

Further, in the image photographing device 3 in the first and the second embodiments, the controller 58 defines, as the ROI, the range of the same size as the size of the workpiece W within the image centering around the x-coordinate and the y-coordinate of the centroid of the image of the workpiece W; however, the ROI is not limited thereto. If there is no restriction on the processing speed or the like, then the ROI may alternatively be set to a wider range and the partial readout region 34 of the image sensor 32 may be set to be larger than the workpiece W.

Further, regarding the image photographing device 3 in the first and the second embodiments, the case where the robot apparatus 1 is applied as the production system has been described; however, the application of the image photographing device 3 is not limited thereto. The image photographing device according to the present invention can be applied to production systems in general that include a production device capable of moving the workpiece W.

Further, in the first and the second embodiments described above, the descriptions have been given of the cases where the camera controllers 50 and 150 are constituted of the FPGA; however, the camera controllers are not limited thereto. For example, the camera controllers 50 and 150 may alternatively be constituted of, for example, computers having CPUs, ROMs, RAMs and various interfaces.

In this case, specifically, the processing operations in the first and the second embodiments are performed by the camera controllers. Hence, recording media, in which software programs for implementing the foregoing functions have been recorded, may be supplied to the camera controllers and the image photographing programs stored in the recording media may be read and executed by the CPUs, thereby implementing the functions. In this case, the programs themselves read from the recording media implement the functions of the foregoing embodiments, so that the programs themselves and the recording media having the programs recorded therein will constitute the present invention.

In the foregoing examples, the descriptions have been given of the cases where the computer-readable recording media are ROMs and the programs are stored in the ROMs; however, the recording media are not limited thereto. The programs may be recorded in any types of recording media insofar as they are computer-readable recording media. For example, an HDD, an external memory, a recording disk or the like may be used as the recording media for supplying the programs.

### Advantageous Effect of the Invention

According to the present invention, the camera controller is capable of estimating the timing, at which an object to be photographed passes through a desired position range, on the basis of a plurality of images obtained by continuous photographing in the first image quality and then photographing the object to be photographed at the estimated timing in a second image quality, which is finer than the first image quality. Thus, a fine image of the object to be photographed can be obtained without stopping the object to be photographed, and since the position of the object to be photographed at the time of photographing in the fine image quality is known, the photographing range can be narrowed, allowing the size of the fine image to be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-165553, filed Aug. 8, 2013, which is hereby incorporated by reference herein in its entirety.

What is claimed is:

1. An image photographing method for an image photographing device that has a camera unit capable of photographing a movable object to be photographed by switching between at least two different image qualities and a camera controller that controls the camera unit to photograph the object to be photographed, the image photographing method comprising:
a first photographing step in which the camera controller carries out continuous photographing in a first image quality;
an estimation calculation step in which the camera controller estimates a timing at which the object to be photographed passes through a predetermined desired position range on the basis of a plurality of positions of the object to be photographed, the plurality of positions of the object to be photographed being obtained from images photographed in the first photographing step; and
a second photographing step in which the camera controller carries out photographing at the passing timing in a second image quality, the second image quality being finer than the first image quality.

2. The image photographing method according to claim 1,
wherein the estimation calculation step calculates a movement path of the object to be photographed on the basis of the plurality of positions of the object to be photographed, the plurality of positions of the object to be photographed being obtained from the images photographed in the first photographing step, and
wherein the estimation calculation step estimates the passing timing on the basis of the movement path.

3. The image photographing method according to claim 1,
wherein the camera controller carries out photographing, taking the size of the object to be photographed as a photographing range in the second photographing step.

4. The image photographing method according to claim 1,
wherein the estimation calculation step calculates the passing timing by using a plurality of images obtained by binarizing the plurality of images photographed in the first photographing step.

5. The image photographing method according to claim 1,
wherein the estimation calculation step compares the photographing brightness levels of corresponding pixels of two consecutive images among the plurality of images photographed in the first photographing step, and in the case where a difference in the photographing brightness is a predetermined threshold value or less, the photographing brightness is changed to a first brightness level by using the pixels as a background, and in the case where a difference in the photographing brightness exceeds the threshold value, the pixels are changed to a second brightness level, the second brightness level being different from the first brightness level, thereby to remove a background, and the passing timing is calculated by using a plurality of images having the backgrounds thereof removed.

6. A computer-readable recording medium in which the image photographing program for having a computer carry out the steps of the image photographing method according to claim 1 has been recorded.

7. An image photographing device comprising:
a camera unit that has a photographing optical system and an image sensor and is capable of photographing a movable object to be photographed by switching between at least two different image qualities; and
a camera controller that controls the camera unit to photograph the object to be photographed,
wherein the camera controller carries out continuous photographing in a first image quality, estimates a timing at which the object to be photographed passes through a predetermined desired position range on the basis of a plurality of positions of the object to be photographed, the plurality of positions of the object to be photographed being obtained from photographed images in the continuous photographing, and carries out photographing at the passing timing in a second image quality, the second image quality being finer than the first image quality.

8. The image photographing device according to claim 7,
wherein the camera controller calculates a movement path of the object to be photographed on the basis of the plurality of positions of the object to be photographed, the plurality of positions of the object to be photographed being obtained from the images photographed in the first image quality, and estimates the passing timing on the basis of the movement path.

9. The image photographing device according to claim 7,
wherein the camera controller carries out photographing, taking the size of the object to be photographed as a photographing range in photographing in the second image quality.

10. The image photographing device according to claim 7,
wherein the camera controller calculates the passing timing by using a plurality of images obtained by binarizing the plurality of images photographed in the first image quality.

11. The image photographing device according to claim 7,
wherein the camera controller compares the photographing brightness levels of corresponding pixels of two consecutive images among the plurality of images photographed in the first image quality, and in the case where a difference in the photographing brightness is a predetermined threshold value or less, the photographing brightness is changed to a first brightness level by using the pixels as a background, and in the case where a difference in the photographing brightness exceeds the threshold value, the pixels are changed to a second brightness level, the second brightness level being different from the first brightness level, thereby to remove a background, and the passing timing is calculated by using a plurality of images having the backgrounds thereof removed.

12. A production system comprising:
a production device capable of moving an object to be photographed; and
the image photographing device according to claim 7.

13. The production system according to claim 12,
wherein the production device is a multi-joint robot capable of grasping and moving, with a grasping tool, the object to be photographed.
